(19) United States
(12) Patent Application Publication
(10) Pub. No.: US 2026/0106738 A1
(43) Pub. Date: Apr. 16, 2026

(54) System and method for establishing a secure quantum key distribution communications protocol based on quantum entanglement

(71) Applicant: Bank of America Corporation, Charlotte, NC (US)

(72) Inventors: Adam K. King, Fort Mill, SC (US); James Siekman, Charlotte, NC (US); Sanjay Lohar, Mint Hill, NC (US); Matthew K. Bryant, Mt. Holly, NC (US); Catherine Cunningham, Charlotte, NC (US); Takiyah Watford, Fort Mill, SC (US); Elizabeth Swanzy-Parker, Charlotte, NC (US); Peter Nein, Waxhaw, NC (US)

(21) Appl. No.: 18/916,177

(22) Filed: Oct. 15, 2024

(51) Int. Cl. H04L 9/08; G06N 10/40

(52) U.S. Cl. CPC H04L 9/0858; G06N 10/40; H04L 9/0816; H04L 9/0819; H04L 9/0852

(57) ABSTRACT

A system includes a quantum memory configured to store a first quantum cryptographic key and a quantum processor operably coupled to the quantum memory and configured to generate pairs of entangled quantum bits (QuBits). The pairs of entangled QuBits include the first quantum cryptographic key. The quantum processor is further configured to determine, based on one Qubit of each pair of entangled QuBits, a first set of measurements, transmit the pairs of entangled QuBits to the quantum computing device, and in response to transmitting the pairs of entangled QuBits, receive, from the quantum computing device, a second set of measurements of each pair of entangled QuBits. The quantum processor is further configured to identify, based on a comparison of the first set of measurements and the second set of measurements, a second quantum cryptographic key. The second quantum cryptographic key is between the system and the quantum computing device.

### TECHNICAL FIELD

The present disclosure relates generally to quantum computing, and, more specifically, to a system and method for establishing a secure quantum key distribution communications protocol based on quantum entanglement.

### BACKGROUND

Existing public-key encryption algorithms, such as Rivest-Shamir-Adleman (RSA) encryption algorithms, face significant challenges in ensuring the security of communication channels against sophisticated cyberattacks and cyberthreats, such as those that may be implemented utilizing quantum computing. Specifically, existing RSA encryption algorithms rely on the assumption that factoring large prime numbers is computationally intensive for classical computing systems, and thus ensure the secure transmission and reception of sensitive data over communication channels. However, because quantum computing systems may be especially suited for “cracking” RSA encryption algorithms rather trivially (e.g., by way of Shor's algorithm), “harvest now, decrypt later” (HNDL) attacks may allow an attacker, an eavesdropper, or other adversarial user to intercept and store encrypted data until a future time at which quantum computing systems and resources are more feasible and readily available to decrypt the intercepted and harvested encrypted data.

### SUMMARY

The system and methods implemented by the system as disclosed in the present disclosure provide technical solutions to the technical problems discussed above by providing systems and methods for establishing a secure quantum key distribution communications protocol based on quantum entanglement. The disclosed system and methods provide several practical applications and technical advantages. Specifically, the present embodiments improve the security and network efficiency of optical communications channels by generating and establishing a secure quantum entanglement key distribution (QEKD) communications protocol in accordance with the principles of quantum entanglement.

Specifically, the present embodiments provide a quantum computing system that may be utilized to generate one or more pairs of entangled quantum bits (QuBits), in which the one or more pairs of entangled QuBits includes a first quantum cryptographic key. The quantum computing system may then determine, based on a measure of one Qubit of each of the one or more pairs of entangled QuBits, a first set of measurements and transmit the one or more pairs of entangled QuBits over an optical communication channel to a receiving quantum computing device.

In response to transmitting the one or more pairs of entangled QuBits to the receiving quantum computing device, the quantum computing system may then receive, from the receiving quantum computing device, a second set of measurements of each of the one or more pairs of entangled QuBits. The quantum computing system may then identify, based on a comparison of the first set of measurements and the second set of measurements, a second quantum cryptographic key, in which the second quantum cryptographic key is configured to be shared between the quantum computing system and the receiving quantum computing device.

Thus, in accordance with the presently disclosed embodiments, the first set of measurements and the second set of measurements may be expected to match (e.g., due to the entanglement of the pair of entangled QuBits). Accordingly, when the quantum computing system and the receiver quantum computing device each independently measures the one or more pairs of entangled QuBits as being the same, the quantum computing system may then identify the second quantum cryptographic key to be shared between the quantum computing system and the receiver quantum computing device for securing communications between the quantum computing system and the receiver quantum computing device.

On the other hand, when the quantum computing system and the receiver quantum computing device fails to independently measure the one or more pairs of entangled QuBits as being the same, the quantum computing system may detect or identify that an unauthorized observance (e.g., an unauthorized measurement) of the one or more pairs of entangled QuBits was performed during the transmission of the one or more pairs of entangled QuBits to the receiver quantum computing device. That is, in accordance with the presently disclosed embodiments, and, further in accordance with the principles of quantum entanglement, failing to identify a match between the first set of measurements and the second set of measurements may indicate that an unauthorized measure of the one or more pairs of entangled QuBits was performed, for example, by an attacker, an eavesdropper, or other adversarial user.

Accordingly, utilizing the quantum computing system and leveraging the principles of quantum entanglement, the present embodiments improve the security and network efficiency of optical communications channels by generating and establishing a secure quantum entanglement key distribution (QEKD) communications protocol based on quantum entanglement. Specifically, in accordance with the principles of quantum entanglement, QuBits interact with each other and are represented by reference to one another, regardless of whether the QuBits are spatially close together or separated spatially by a large distance. For example, at the time of measurement, if one entangled QuBit in a pair of entangled QuBits is determined to be in a spin state of “down,” the quantum computing system may then immediately configure the other entangled QuBit in the pair of entangled QuBits to assume the opposite spin state of “up,” for example.

That is, in accordance with the principles of quantum entanglement, QuBits, even those that are spatially far away from each other, interact instantaneously with each other. In this way, if an attacker, an eavesdropper, or other adversarial user interacts with even just one of a pair of entangled QuBits, the other one of the pair of entangled QuBits will also be instantaneously impacted by the interaction (e.g., regardless of whether the individual QuBits are spatially close together or separated spatially by a large distance). Accordingly, utilizing the quantum computing system and leveraging the principles of quantum entanglement, the present embodiments improve the security and network efficiency of optical communications channels by generating and establishing a secure QEKD communications protocol, which ensures secure sensitive data communications between sending quantum computing systems and receiving quantum computing systems and the secure transmission and reception of sensitive data over optical communication channels.

Additionally, even though quantum computing systems may be especially suited for “cracking” RSA encryption algorithms rather trivially (e.g., by way of Shor's algorithm), the present embodiments further obviate the threat of “harvest now, decrypt later” (HNDL) by generating and establishing a secure QEKD communications protocol that is wholly independent of traditional RSA encryption algorithms.

The present embodiments are directed to systems and methods for establishing a secure quantum key distribution communications protocol based on quantum entanglement. In particular embodiments, a system includes a quantum memory configured to store a first quantum cryptographic key to be transmitted to a quantum computing device over an optical communication channel. In one embodiment, the optical communication channel may include one or more of an optical fiber link or a free-space optical link. In particular embodiments, the system may further include one or more quantum processors operably coupled to the quantum memory and configured to generate one or more pairs of entangled quantum bits (QuBits). In one embodiment, the one or more pairs of entangled QuBits may include the first quantum cryptographic key.

In particular embodiments, the one or more pairs of entangled QuBits may include one or more pairs of entangled photons, one or more pairs of entangled electrons, one or more pairs of entangled neuronal impulses, or one or more pairs of entangled subatomic particles. In particular embodiments, the one or more quantum processors may be further configured to determine, based at least in part on one Qubit of each pair of the one or more pairs of entangled QuBits, a first set of measurements of each pair of the one or more pairs of entangled QuBits. In one embodiment, the first set of measurements may include one or more measurements of a first quantum bit error rate (QBER), a first Bell parameter, and a first amount of the first quantum cryptographic key shared between the system and the quantum computing device.

In particular embodiments, the one or more quantum processors may be further configured to transmit, over the optical communication channel, the one or more pairs of entangled QuBits to the quantum computing device. In particular embodiments, in response to transmitting the one or more pairs of entangled QuBits to the quantum computing device, the one or more quantum processors may be further configured to receive, from the quantum computing device, a second set of measurements of each pair of the one or more pairs of entangled QuBits. In particular embodiments, the second set of measurements may include one or more measurements of a second quantum bit error rate (QBER), a second Bell parameter, and a second amount of the first quantum cryptographic key shared between the system and the quantum computing device.

In particular embodiments, the one or more quantum processors may be further configured to identify, based at least in part on a comparison of the first set of measurements and the second set of measurements, a second quantum cryptographic key, wherein the second quantum cryptographic key is configured to be shared between the system and the quantum computing device. In particular embodiments, the one or more quantum processors may be further configured to compare the first set of measurements and the second set of measurements, identify the second quantum cryptographic key based at least in part on a determination that one or more measurements of the first set of measurements matches to one or more measurements of the second set of measurements, and transmit, over the optical communication channel, the second quantum cryptographic key to the quantum computing device.

In particular embodiments, the one or more quantum processors may be further configured to identify, based at least in part on one Qubit of each pair of the one or more pairs of entangled QuBits, whether an observance of the one or more pairs of entangled QuBits was performed during the transmission of the one or more pairs of entangled QuBits to the quantum computing device, and in response to identifying that the observance of the one or more pairs of entangled QuBits was performed, destroy the one or more pairs of entangled QuBits.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a diagram of a quantum entanglement key distribution (QEKD) communications protocol architecture, in accordance with one or more embodiments of the present disclosure; and

FIG. 3 illustrates a flowchart of an example method for establishing a secure quantum key distribution communications protocol based on quantum entanglement, in accordance with one or more embodiments of the present disclosure.

### DETAILED DESCRIPTION

### Example System

### System Overview

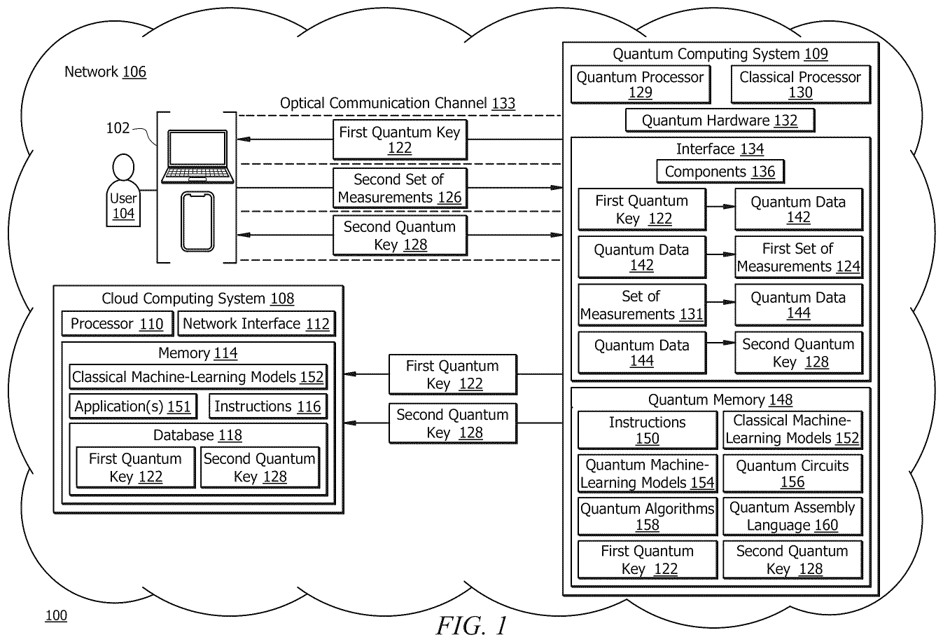

FIG. 1 is a block diagram of a combined classical computing and quantum computing system 100. As depicted, the combined classical computing and quantum computing system 100 may include one or more computing devices 102 that may be associated with a user 104, a cloud computing system 108, a quantum computing system 109, and a network 106 that enables the communications between the one or more computing devices 102, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure. In general, the combined classical computing and quantum computing system 100 may be utilized to establish a secure quantum key distribution communications protocol based on quantum entanglement.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

### Network

Network 106 may be any suitable type of wireless and/or wired network. The network 106 may or may not be connected to the Internet or public network. The network 106 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 106 may be configured to support any suitable type of communication protocol as would be appreciated by one of ordinary skill in the art.

### Computing Device

Computing device 102 is generally any device that may be utilized to process data and interact with a user 104. Examples of the computing device 102 include, but are not limited to, a personal computer, a desktop computer, a workstation, a server, a laptop, a tablet computer, a mobile phone (such as a smartphone), etc. The computing device 102 may include a user interface, such as a display, a microphone, keypad, or other appropriate terminal equipment usable by the user 104. The computing device 102 may include a hardware processor, memory, and/or circuitry (not explicitly shown) configured to perform any of the functions or actions of the computing device 102 described herein. For example, a software application designed using software code may be stored in the memory and executed by the processor to perform the functions of the computing device 102. The computing device 102 may be utilized to communicate with other components of the system 100 via the network 106.

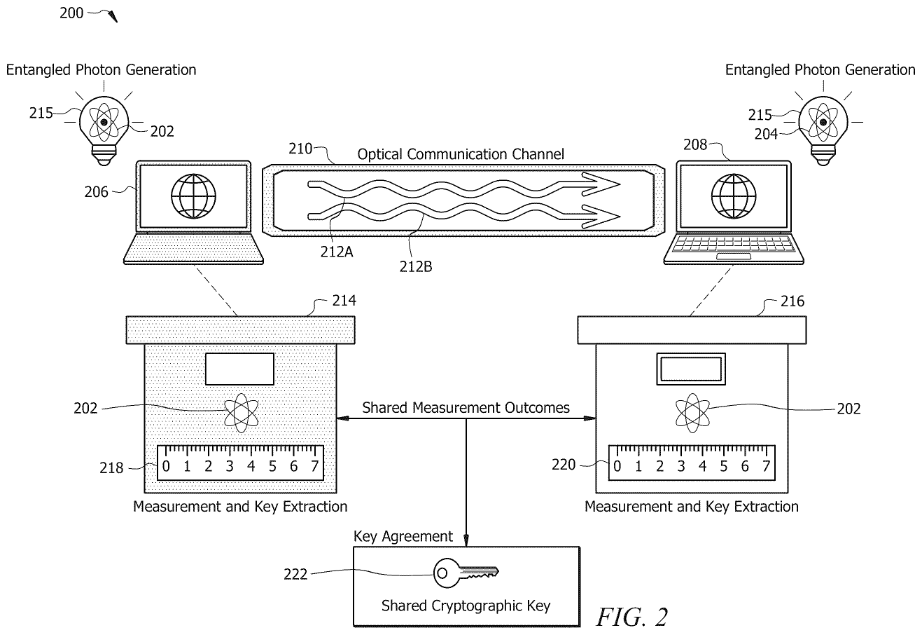

In particular embodiments, the computing device 102 may include a quantum computing device 102 suitable for executing superposed and entangled QuBit based parallel processing operations. For example, in particular embodiments, as will be further discussed below with respect to FIG. 2, the quantum computing device 102 may be utilized by the user 104 to communicate and exchange data over the network 106 or an optical communication channel 133 to the quantum computing system 109 and/or the cloud computing system 108. For example, as will be discussed in greater detail below, the quantum computing device 102 may receive, over the optical communication channel 133, one or more pairs of entangled QuBits including a first quantum cryptographic key 122 from the quantum computing system 109 and may provide, over the optical communication channel 133, a second set of measurements 126 of one or more pairs of entangled QuBits.

In particular embodiments, the optical communication channel 133 may include one or more of an optical fiber link (e.g., one or more fiber optic cables) or a free-space optical link (e.g., photons of light emitted through free space) that may be established between the computing device 102 and the quantum computing system 109. For example, in particular embodiments, the first quantum cryptographic key 122, the second set of measurements 126 of one or more pairs of entangled QuBits, and the second quantum cryptographic key 128 may be transmitted between the quantum computing system 109 and the quantum computing device 102 as one or more rays or streams of photons of light or entangled photons of light.

### Cloud Computing System

The cloud computing system 108 may include any computing that may be utilized to process data and communicate with other components of the system 100 via the network 106. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 106). The network interface 112 is configured to communicate data between the cloud computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1-3 along with any other data, instructions, logic, rules, or code operable to implement the function(s) described herein. The memory 114 is operable to store software instructions 116, and/or any other data and instructions.

The software instructions 116 may include any suitable set of software instructions, logic, rules, or code operable to be executed by the processor 110. In particular embodiments, the memory 114 may further store a database 118, which may include a structured data base (e.g., structured query language (SQL) database, a non-SQL database, or other similar relational database), an unstructured database, a sorted data structure, or an unsorted data structure. In one embodiment, the memory 114 may be understood to be a classical memory. In one embodiment, the memory 114 may include a non-transitory computer-readable medium. In particular embodiments, the database 118 may be utilized to store the first quantum cryptographic key 122 and the second quantum cryptographic key 128 as one or more classical binary bits of data.

### Quantum Computing System

The quantum computing system 109 may include any quantum computing system that may be utilized to process data and communicate with other components of the system 100 via the network 106 and/or the optical communication channel 133. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with QuBits implemented by states of Josephson junctions), a trapped ion device (with qubits implemented by internal states of trapped ions), a trapped neutral atom device (with QuBits implemented by internal states of trapped neutral atoms), a photon-based device (with QuBits implemented by modes of photons), or any other suitable device that implements quantum bits with states of a respective quantum system.

In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the first quantum cryptographic key 122, the first set of measurements 124 of one or more pairs of entangled QuBits, and the second set of measurements 126 of one or more pairs of entangled QuBits, the second quantum cryptographic key 128.

For example, as will be discussed in greater detail below with respect to FIG. 2, the first set of measurements 124 of one or more pairs of entangled QuBits and the second set of measurements 126 of one or more pairs of entangled QuBits may be utilized to generate the second quantum cryptographic key 128, which may be shared between the quantum computing system 109 and the quantum computing device 102 for securing all communications between the quantum computing system 109 and the quantum computing device 102 in accordance with the presently disclosed embodiments.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, or other similar machine-learning model. In another embodiment, the one or more classical machine-learning (CML) models 152 may include one or more language models (LMs) or large language model (LLMs).

Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks. Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover's algorithm), quantum cryptography algorithms (e.g., Shor's algorithm), one or more quantum Fourier transform (QFT) based algorithms or inverse quantum Fourier transform (iQFT) based algorithms, one or more classical quantum hybrid algorithms (e.g., Quantum Eigensolver), one or more classical quantum variational algorithms, one or more post-quantum cryptographic algorithms (e.g., quantum-resistant encryption algorithms), and/or other user-developed quantum algorithms that may be represented by instructions 150.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in some embodiments, the interface 134 may convert first quantum cryptographic key 122 data represented as classical binary bits of data into quantum data 142 for further processing, and, similarly, convert sets of measurements 131 represented as classical binary bits of data into quantum data 144 for further processing, for example. In particular embodiments, the quantum data 142 and the quantum data 144 may represent one or more pairs of entangled QuBits.

In particular embodiments, the interface 134 may be further utilized to convert data items represented by quantum bits (QuBits) of data into classical binary bits of data. For example, in particular embodiments, upon the quantum computing system 109 extracting data from the first quantum cryptographic key 122 based on the quantum data 142, the interface 134 may convert the quantum data 142 representing the first quantum cryptographic key 122 into classical binary bits of data representing the first set of measurements 124. Likewise, upon the quantum computing system 109 generating or receiving the sets of measurements 131 based on the quantum data 144, the interface 134 may convert the quantum data 144 representing the second quantum cryptographic key 128 into classical binary bits of data representing the second quantum cryptographic key 128.

In particular embodiments, the interface 134 may include a number of components 136 that may be utilized to generate and manipulate quantum bits (QuBits). In the illustrated embodiment, the number of components 136 and the quantum processor 129 are configured to operate on a same type of quantum bits (QuBits). For example, when the quantum processor 129 includes a photon-based device (with QuBits implemented by modes of photons), the number of components 136 may include optical components such as lasers, mirrors, prisms, waveguides, interferometers, optical fibers, filters, polarizers, and/or lenses. In particular embodiments, the number of components 136 may further include one or more quantum-based light sources, such as one or more semiconductor quantum dots (QDs), a high-intensity laser, a quantum particle generator, or other similar quantum-based light source that may be utilized to generate one or more pairs of entangled QuBits.

For example, in accordance with presently disclosed embodiments, the quantum computing system 109 may utilize the number of components 136 to generate one or more pairs of entangled quantum bits QuBits, in which the one or more pairs of entangled QuBits includes the first quantum cryptographic key 122. In particular embodiments, the quantum processor 129 may then determine, based on one Qubit of each pair of the one or more pairs of entangled QuBits, the first set of measurements 124. The quantum processor 129 may then transmit, over the optical communication channel 133, the one or more pairs of entangled QuBits to the quantum computing device 102.

In particular embodiments, in response to transmitting the one or more pairs of entangled QuBits to the quantum computing device 102, the quantum processor 129 may then receive, from the quantum computing device 102, a second set of measurements 126. In particular embodiments, the quantum processor 129 may then identify, based on a comparison of the first set of measurements 124 and the second set of measurements 126, the second quantum cryptographic key 128. For example, in accordance with the presently disclosed embodiments, the second quantum cryptographic key 128 may be generated and shared between the quantum computing system 109 and the quantum computing device 102 for securing communications over the optical communication channel 133 between the quantum computing system 109 and the quantum computing device 102.

Quantum memory 148 may include a quantum read-only memory (QROM), quantum random-access memory (QRAM), or other similar quantum memory. The quantum memory 148 may store any of the information described in FIGS. 1 and 2 along with any other data, instructions, logic, rules, or code operable to implement the function(s) described herein. The quantum memory 148 is operable to store software instructions 150, and/or any other data and instructions. The software instructions 150 may include any suitable set of software instructions, logic, rules, or code operable to be executed by the quantum processor 129. In one embodiment, the quantum memory 148 may include a non-transitory computer-readable medium.

In another embodiment, the quantum memory 148 may include a quantum storage medium 214, which may be utilized to store the one or more pairs of entangled QuBits once generated by the one or more quantum light sources (e.g., semiconductor QDs, high-intensity laser, quantum particle generator). For example, in one embodiment, the quantum memory 148 may include, for example, a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, a controlled reversible inhomogeneous broadening of a single atomic absorption line (CRIB) storage medium, or other similar quantum storage medium.

### Establishing a Secure Quantum Key Distribution Communications Protocol Based on Quantum Entanglement

Embodiments of the present disclosure discuss techniques for establishing a secure quantum key distribution communications protocol based on quantum entanglement.

FIG. 2 illustrates a diagram of a quantum entanglement key distribution (QEKD) communications protocol architecture 200 that may be utilized to establish a secure quantum key distribution communications protocol based on quantum entanglement, in accordance with certain aspects of the present disclosure. In one embodiment, the QEKD communications protocol architecture 200 may be a further illustrative example of the combined classical computing and quantum computing system 100 as described above with respect to FIG. 1.

As depicted, the QEKD communications protocol architecture 200 may include one or more pairs of entangled QuBits 202, 204, a sender quantum computing system 206, and a receiver quantum computing system 208 that may be optically coupled to the sender quantum computing system 206 by way of an optical communication channel 210. In one embodiment, the sender quantum computing system 206 may correspond to the computing device 102, the receiver quantum computing system 208 may correspond to the quantum computing system 109, and the optical communication channel 210 may correspond to the optical communication channel 133 as all described above with respect to FIG. 1. Furthermore, in accordance with the presently disclosed embodiments, the sender quantum computing system 206 and the receiver quantum computing system 208 may each include one or more quantum processors, such as the quantum processor 129 as further described above with respect to FIG. 1.

In particular embodiments, the one or more pairs of entangled QuBits 202, 204 may be generated, for example, by utilizing one or more quantum-based light sources 215. In one embodiment, the one or more quantum-based light sources 215 may include, for example, one or more semiconductor quantum dots (QDs), a high-intensity laser, a quantum particle generator, or other similar quantum-based light source 215. In particular embodiments, the one or more pairs of entangled QuBits 202, 204 may include a first quantum cryptographic key, which may be transmitted from the sender quantum computing system 206 to the receiver quantum computing system 208 over the optical communication channel 133 (e.g., optical fiber link, free-space optical link) as one or more rays or streams of entangled photons of light 212A, 212B.

In particular embodiments, as further depicted by FIG. 2, the sender quantum computing system 206 may include a quantum storage medium 214, which may be utilized to store the one or more pairs of entangled QuBits 202, 204 once generated by the one or more quantum light sources 215 (e.g., semiconductor QDs, high-intensity laser, quantum particle generator). Similarly, the receiver quantum computing system 208 may include a quantum storage medium 216. For example, in one embodiment, the quantum storage medium 214 and the storage medium 216 may each include, for example, a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, a controlled reversible inhomogeneous broadening of a single atomic absorption line (CRIB) storage medium, or other similar quantum storage medium.

In particular embodiments, the sender quantum computing system 206 may then determine, by measuring one Qubit of each of the one or more pairs of entangled QuBits 202, 204, a first set of measurements 218. For example, in one embodiment, the first set of measurements 218 may include one or more measurements of a first quantum bit error rate (QBER), a first Bell parameter (e.g., S₁), and a first amount of the first quantum cryptographic key shared between the sender quantum computing system 206 and the receiver quantum computing system 208. In particular embodiments, upon the sender quantum computing system 206 transmitting the one or more pairs of entangled QuBits 202, 204 to the receiver quantum computing system 208, the receiver quantum computing system 208 may then store the one or more pairs of entangled QuBits 202, 204 to the quantum storage medium 216.

In particular embodiments, upon storing the one or more pairs of entangled QuBits 202, 204 to the quantum storage medium 216, the receiver quantum computing system 208 may then determine, by measuring the one Qubit of each of the one or more pairs of entangled QuBits 202, 204, a second set of measurements 220. For example, in one embodiment, the second set of measurements 220 may include one or more measurements of a second QBER, a second Bell parameter (e.g., S₂), and a second amount of the first quantum cryptographic key shared between the sender quantum computing system 206 and the receiver quantum computing system 208.

In particular embodiments, the receiver quantum computing system 208 may then transmit the second set of measurements 220 to the sender quantum computing system 206. In one embodiment, the receiver quantum computing system 208 may transmit the second set of measurements 220 to the sender quantum computing system 206 over a communications network, such as the network 106. In another embodiment, the receiver quantum computing system 208 may transmit the second set of measurements 220 to the sender quantum computing system 206 over the optical communication channel 133 (e.g., optical fiber link, free-space optical link).

In particular embodiments, upon the sender quantum computing system 206 receiving the second set of measurements 220, the sender quantum computing system 206 may then compare the first set of measurements 218 and the second set of measurements 220. For example, in particular embodiments, the sender quantum computing system 206 may compare the first set of measurements 218 and the second set of measurements 220 to determine whether one or more measurements of the first set of measurements 218 (e.g., one or more measurements of the first QBER, the second Bell parameter S₁, and the first amount of the first quantum cryptographic key shared) matches to one or more measurements of the second set of measurements 220 (e.g., one or more measurements of the second QBER, the second Bell parameter S₂, and the second amount of the first quantum cryptographic key shared).

In particular embodiments, upon the sender quantum computing system 206 identifying a match between one or more measurements of the first set of measurements 218 and one or more measurements of the second set of measurements 220, the sender quantum computing system 206 may then identify a second quantum cryptographic key 222 to be shared between the sender quantum computing system 206 and the receiver quantum computing system 208. For example, in accordance with the presently disclosed embodiments, due to the one or more pairs of entangled QuBits 202, 204 being generated, stored, and measured in accordance with the principles of quantum entanglement, the one or more pairs of entangled QuBits 202, 204 may interact with each other and may be further represented by reference to one another (e.g., regardless of whether the individual QuBits are spatially close together or separated spatially by a large distance).

Thus, in accordance with the presently disclosed embodiments, the first set of measurements 218 and the second set of measurements 220 may be expected to match (e.g., due to the entanglement of the QuBits). Accordingly, when the sender quantum computing system 206 and the receiver quantum computing system 208 each independently measures the one or more pairs of entangled QuBits 202, 204 as being the same, the sender quantum computing system 206 may then identify the second quantum cryptographic key 222 to be shared between the sender quantum computing system 206 and the receiver quantum computing system 208 for securing communications between the sender quantum computing system 206 and the receiver quantum computing system 208. In particular embodiments, the sender quantum computing system 206 may then transmit the second quantum cryptographic key 222 to the receiver quantum computing system 208.

In particular embodiments, upon the sender quantum computing system 206 failing to identifying a match between one or more measurements of the first set of measurements 218 and one or more measurements of the second set of measurements 220, the sender quantum computing system 206 may detect or identify that an unauthorized observance (e.g., a measurement) of the one or more pairs of entangled QuBits 202, 204 was performed during the transmission of the one or more pairs of entangled QuBits 202, 204 to the receiver quantum computing system 208.

That is, in accordance with the presently disclosed embodiments (e.g., in accordance with the principles of quantum entanglement), failing to identify a match between the first set of measurements 218 and the second set of measurements 220 may indicate that an unauthorized measure of the one or more pairs of entangled QuBits 202, 204 was performed, for example, by a potential attacker, an eavesdropper, or other adversarial user. In such an instance, in response to identifying an unauthorized observance (e.g., a measurement) of the one or more pairs of entangled QuBits 202, 204, the sender quantum computing system 206 may destroy the one or more pairs of entangled QuBits 202, 204.

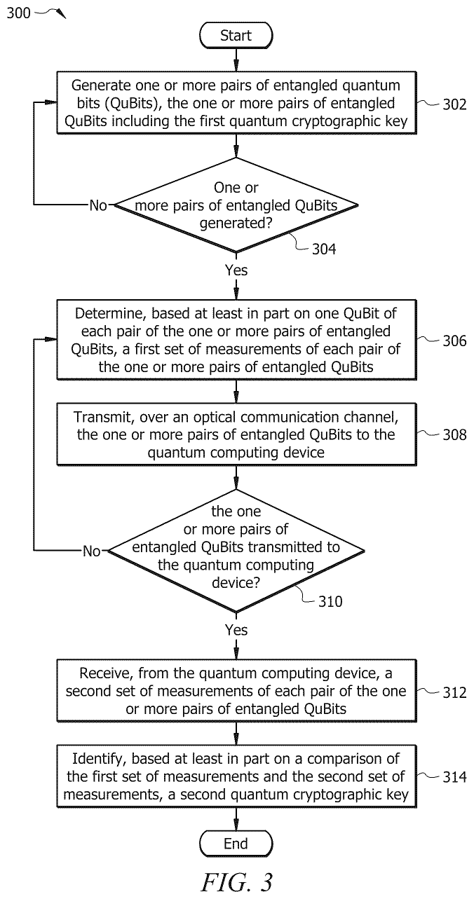

FIG. 3 illustrates a flowchart of an example method 300 for establishing a secure quantum key distribution communications protocol based on quantum entanglement, in accordance with one or more embodiments of the present disclosure. The method 300 may be performed by the combined classical computing and quantum computing system 100 as described above with respect to FIG. 1. For example, in one embodiment, the method 300 may be performed by the quantum computing device 102 alone. In another embodiment, the method 300 may be performed by the quantum computing system 109 alone. In yet another embodiment, the method 300 may be performed in conjunction by the quantum computing device 102 and the quantum computing system 109.

The method 300 may begin at block 302 with the quantum computing system 109 generating one or more pairs of entangled quantum bits (QuBits) 202, 204, in which the one or more pairs of entangled QuBits 202, 204 includes a first quantum cryptographic key. In particular embodiments, the method 300 may continue at decision 304 with the quantum computing system 109 confirming whether the one or more pairs of entangled QuBits 202, 204 have been generated. In particular embodiments, in response to confirming that the one or more pairs of entangled QuBits 202, 204 have not been detected (e.g., at decision 304), the method 300 may return to block 302.

On the other hand, in response to confirming that the one or more pairs of entangled QuBits 202, 204 have been generated (e.g., at decision 304), the method 300 may continue at block 306 with the quantum computing system 109 determining, based at least in part on one QuBit of each pair of the one or more pairs of entangled QuBits 202, 204, a first set of measurements 218 of each pair of the one or more pairs of entangled QuBits 202, 204. For example, in particular embodiments, the quantum computing system 109 may determine the first set of measurements 218, which may include one or more measurements of a first QBER, a first Bell parameter (e.g., S₁), and a first amount of the first quantum cryptographic key shared between, for example, the quantum computing device 102 and the quantum computing system 109.

In particular embodiments, the method 300 may continue at block 308 with the quantum computing system 109 transmitting, over an optical communication channel 133, the one or more pairs of entangled QuBits 202, 204 to the quantum computing device 102. In particular embodiments, the method 300 may continue at decision 310 with the quantum computing system 109 confirming whether the one or more pairs of entangled QuBits 202, 204 have been transmitted to the quantum computing device 102. In particular embodiments, in response to confirming that the one or more pairs of entangled QuBits 202, 204 have not been transmitted to the quantum computing device 102 (e.g., at decision 310), the method 300 may return to block 306.

On the other hand, in response to confirming that the one or more pairs of entangled QuBits 202, 204 have been transmitted to the quantum computing device 102 (e.g., at decision 310), the method 300 may continue at block 312 with the quantum computing system 109 receiving, from the quantum computing device 102, a second set of measurements 220 of each pair of the one or more pairs of entangled QuBits 202, 204. For example, in particular embodiments, the quantum computing device 102 may determine the second set of measurements 220, which may include one or more measurements of a second QBER, a second Bell parameter (e.g., S₂), and a second amount of the first quantum cryptographic key shared between, for example, the quantum computing device 102 and the quantum computing system 109.

In particular embodiments, the method 300 may then conclude at block 314 with the quantum computing system 109 identifying, based at least in part on a comparison of the first set of measurements 218 and the second set of measurements 220, a second quantum cryptographic key 222. For example, in accordance with the presently disclosed embodiments, the first set of measurements 218 and the second set of measurements 220 are expected to match (e.g., due to the entanglement of the QuBits). Accordingly, when the quantum computing system 109 and the quantum computing device 102 each independently measures the one or more pairs of entangled QuBits 202, 204 as being the same, the quantum computing system 109 may then identify the second quantum cryptographic key 222 to be shared between the quantum computing system 109 and the quantum computing device 102.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a quantum memory configured to store a first quantum cryptographic key to be transmitted to a quantum computing device over an optical communication channel; and
one or more quantum processors operably coupled to the quantum memory and configured to:
generate one or more pairs of entangled quantum bits (QuBits), wherein the one or more pairs of entangled QuBits comprises the first quantum cryptographic key;
determine, based at least in part on one Qubit of each pair of the one or more pairs of entangled QuBits, a first set of measurements of each pair of the one or more pairs of entangled QuBits;
transmit, over the optical communication channel, the one or more pairs of entangled QuBits to the quantum computing device;
in response to transmitting the one or more pairs of entangled QuBits to the quantum computing device, receive, from the quantum computing device, a second set of measurements of each pair of the one or more pairs of entangled QuBits; and
identify, based at least in part on a comparison of the first set of measurements and the second set of measurements, a second quantum cryptographic key, wherein the second quantum cryptographic key is configured to be shared between the system and the quantum computing device.

2. The system of claim 1, wherein the first set of measurements comprises one or more measurements of a first quantum bit error rate (QBER), a first Bell parameter, and a first amount of the first quantum cryptographic key shared between the system and the quantum computing device.

3. The system of claim 1, wherein the second set of measurements comprises one or more measurements of a second quantum bit error rate (QBER), a second Bell parameter, and a second amount of the first quantum cryptographic key shared between the system and the quantum computing device.

4. The system of claim 1, wherein the one or more quantum processors are further configured to:
compare the first set of measurements and the second set of measurements;
identify the second quantum cryptographic key based at least in part on a determination that one or more measurements of the first set of measurements matches to one or more measurements of the second set of measurements; and
transmit, over the optical communication channel, the second quantum cryptographic key to the quantum computing device.

5. The system of claim 1, wherein the one or more quantum processors are further configured to:
identify, based at least in part on one Qubit of each pair of the one or more pairs of entangled QuBits, whether an observance of the one or more pairs of entangled QuBits was performed during the transmission of the one or more pairs of entangled QuBits to the quantum computing device; and
in response to identifying that the observance of the one or more pairs of entangled QuBits was performed, destroy the one or more pairs of entangled QuBits.

6. The system of claim 1, wherein the one or more pairs of entangled QuBits comprises one or more pairs of entangled photons, one or more pairs of entangled electrons, one or more pairs of entangled neuronal impulses, or one or more pairs of entangled subatomic particles.

7. The system of claim 1, wherein the optical communication channel comprises one or more of an optical fiber link or a free-space optical link.

8. A method, comprising:
generating one or more pairs of entangled quantum bits (QuBits), wherein the one or more pairs of entangled QuBits comprises a first quantum cryptographic key, wherein the first quantum cryptographic key is configured to be transmitted to a quantum computing device over an optical communication channel;
determining, based at least in part on one Qubit of each pair of the one or more pairs of entangled QuBits, a first set of measurements of each pair of the one or more pairs of entangled QuBits;
transmitting, over the optical communication channel, the one or more pairs of entangled QuBits to the quantum computing device;
in response to transmitting the one or more pairs of entangled QuBits to the quantum computing device, receiving, from the quantum computing device, a second set of measurements of each pair of the one or more pairs of entangled QuBits; and
identifying, based at least in part on a comparison of the first set of measurements and the second set of measurements, a second quantum cryptographic key, wherein the second quantum cryptographic key is configured to be shared between a system and the quantum computing device.

9. The method of claim 8, wherein the first set of measurements comprises one or more measurements of a first quantum bit error rate (QBER), a first Bell parameter, and a first amount of the first quantum cryptographic key shared between the system and the quantum computing device.

10. The method of claim 8, wherein the second set of measurements comprises one or more measurements of a second quantum bit error rate (QBER), a second Bell parameter, and a second amount of the first quantum cryptographic key shared between the system and the quantum computing device.

11. The method of claim 8, further comprising:
comparing the first set of measurements and the second set of measurements;
identifying the second quantum cryptographic key based at least in part on a determination that one or more measurements of the first set of measurements matches to one or more measurements of the second set of measurements; and
transmitting, over the optical communication channel, the second quantum cryptographic key to the quantum computing device.

12. The method of claim 8, further comprising:
identifying, based at least in part on one Qubit of each pair of the one or more pairs of entangled QuBits, whether an observance of the one or more pairs of entangled QuBits was performed during the transmission of the one or more pairs of entangled QuBits to the quantum computing device; and
in response to identifying that the observance of the one or more pairs of entangled QuBits was performed, destroying the one or more pairs of entangled QuBits.

13. The method of claim 8, wherein the one or more pairs of entangled QuBits comprises one or more pairs of entangled photons, one or more pairs of entangled electrons, one or more pairs of entangled neuronal impulses, or one or more pairs of entangled subatomic particles.

14. The method of claim 8, wherein the optical communication channel comprises one or more of an optical fiber link or a free-space optical link.

15. A non-transitory computer-readable medium storing instructions that, when executed by one or more quantum processors, cause the one or more quantum processors to:
generate one or more pairs of entangled quantum bits (QuBits), wherein the one or more pairs of entangled QuBits comprises a first quantum cryptographic key, wherein the first quantum cryptographic key is configured to be transmitted to a quantum computing device over an optical communication channel;
determine, based at least in part on one Qubit of each pair of the one or more pairs of entangled QuBits, a first set of measurements of each pair of the one or more pairs of entangled QuBits;
transmit, over the optical communication channel, the one or more pairs of entangled QuBits to the quantum computing device;
in response to transmitting the one or more pairs of entangled QuBits to the quantum computing device, receive, from the quantum computing device, a second set of measurements of each pair of the one or more pairs of entangled QuBits; and
identify, based at least in part on a comparison of the first set of measurements and the second set of measurements, a second quantum cryptographic key, wherein the second quantum cryptographic key is configured to be shared between a system and the quantum computing device.

16. The non-transitory computer-readable medium of claim 15, wherein the first set of measurements comprises one or more measurements of a first quantum bit error rate (QBER), a first Bell parameter, and a first amount of the first quantum cryptographic key shared between the system and the quantum computing device.

17. The non-transitory computer-readable medium of claim 15, wherein the second set of measurements comprises one or more measurements of a second quantum bit error rate (QBER), a second Bell parameter, and a second amount of the first quantum cryptographic key shared between the system and the quantum computing device.

18. The non-transitory computer-readable medium of claim 15, wherein the instructions further cause the one or more quantum processors to:
compare the first set of measurements and the second set of measurements;
identify the second quantum cryptographic key based at least in part on a determination that one or more measurements of the first set of measurements matches to one or more measurements of the second set of measurements; and
transmit, over the optical communication channel, the second quantum cryptographic key to the quantum computing device.

19. The non-transitory computer-readable medium of claim 15, wherein the instructions further cause the one or more quantum processors to:
identify, based at least in part on one Qubit of each pair of the one or more pairs of entangled QuBits, whether an observance of the one or more pairs of entangled QuBits was performed during the transmission of the one or more pairs of entangled QuBits to the quantum computing device; and
in response to identifying that the observance of the one or more pairs of entangled QuBits was performed, destroy the one or more pairs of entangled QuBits.

20. The non-transitory computer-readable medium of claim 15, wherein the one or more pairs of entangled QuBits comprises one or more pairs of entangled photons, one or more pairs of entangled electrons, one or more pairs of entangled neuronal impulses, or one or more pairs of entangled subatomic particles.
